(19) United States
(12) Patent Application Publication
(10) Pub. No.: US 2026/0235553 A1
(43) Pub. Date: Aug. 13, 2026

(54) DMS SV Automatic Phase Offset Calibration

(71) Applicant: DH Technologies Development Pte. Ltd., Singapore (SG)

(72) Inventor: Andrei TUDOR, Toronto (CA)

(73) Assignee: DH Technologies Development Pte. Ltd., Singapore (SG)

(21) Appl. No.: 19/160,887

(22) PCT Filed: Feb. 29, 2024
(86) PCT No.: PCT/IB2024/051972

§ 371 Date: Aug. 29, 2025

Related U.S. Application Data
(60) Provisional application No. 63/449,774, filed on Mar. 3, 2023.

(51) Int. Cl. G01N 27/624

(52) U.S. Cl. CPC G01N 27/624

(57) ABSTRACT

In one aspect, a circuit for generating an asymmetric waveform for application to electrodes of a differential mobility mass (DMS) spectrometer is disclosed, which includes two digital waveform synthesizers for generating digital waveforms, which are converted to analog waveforms for application to electrodes of the DMS spectrometer. Analog feedback signals associated with the applied waveforms are digitized and a digital passband filter is employed to filter the digital feedback signals, which are then employed to determine a phase correction signal for application to at least one of the digital waveform synthesizers for maintaining a substantially constant phase difference between the waveforms generated by the digital waveform synthesizers.

### RELATED APPLICATIONS

This application claims priority to U.S. Provisional Application No. 63/449,774 filed on Mar. 3, 2023, the contents of which are incorporated herein in their entirety.

### TECHNICAL FIELD

The present disclosure relates to methods and systems for performing mass spectrometry and more particularly to circuits for generating waveforms for application to electrodes of a differential mobility mass spectrometer.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

In differential mobility mass spectrometry, ions are separated based on the difference in their mobility. More specifically, ions drift through a mobility cell, which typically includes two electrodes that are separated by a substantially uniform gap. The application of an asymmetric waveform to the electrodes can create a separation field that exposes the ions to high and low electric field conditions. An ion will migrate toward one or the other electrode depending on its high field and low field mobility. A small DC field can be applied between the electrodes to steer the ions back to the central axis of the mobility cell such that they can be transmitted to a downstream component, such as a mass spectrometer.

The electrodes utilized in a mobility cell can be, for example, in the form of flat planar electrodes that provide a homogeneous electric field or curved cell geometries that provide inhomogeneous electric field. The former is typically referred to as a differential mobility spectrometer (DMS) and the latter is referred to as a High Field Asymmetric Waveform Ion Mobility Spectrometer, both of which are herein collectively referred to as ion mobility spectrometers.

### SUMMARY

In one aspect, a phase compensation circuit for adjusting a phase difference between first and second analog waveforms applied to two electrodes of a differential mobility mass spectrometer, where the analog waveforms are generated based on digital waveforms produced by first and second digital waveform synthesizers, is disclosed, which includes a feedback circuit for generating first and second analog feedback signals each associated with one of said first and second analog waveforms, at least one analog-to-digital converter configured to receive the first and the second analog feedback signals and convert those analog feedback signals into respective first and second digital feedback signals, at least one digital passband filter configured to receive said first and second digital feedback signals and generate first and second filtered digital feedback signals by substantially filtering out from each of the digital feedback signals associated with each waveform a contribution associated with the other waveform due to cross-talk between said analog waveforms applied to the electrodes. The phase compensation circuit can further include a phase comparator for determining a phase difference between said first and second filtered digital feedback signals, and a controller for applying a phase correction signal determined based on said phase difference to said at least one digital waveform synthesizer In some embodiments, the phase comparator can be configured to apply a discrete transform to said first and second filtered digital feedback signals to generate first and second frequency spectra associated with said first and second filtered digital feedback signals and to utilize said first and second frequency spectra to determine said phase difference. By way of example, the discrete transform comprises a Discrete Fourier Transform.

In some embodiments, the phase compensation circuit can include first and second amplifiers for receiving the first and second analog waveforms and generating first and second amplified analog waveforms.

The phase compensation circuit can further include a feedback circuit for generating the first and the second feedback signals.

In some embodiments, the phase compensation circuit can further include first and second tank circuits for receiving said first and second amplified analog waveforms at inputs thereof, respectively, and generating first and second output analog waveforms at their respective outputs for application to said first and second electrodes of the DMS. By way of example, the tank circuits can be implemented using capacitors and inductors in a manner known in the art as informed by the present teachings. In some embodiments, the first and second tank circuits are configured to have a resonant frequency that is substantially equal to a frequency of said first and second digital waveforms, respectively.

In some embodiments, the feedback circuit includes a first and a second voltage divider electrically coupled to the outputs of the first and the second tank circuits, respectively, to generate said first and second analog feedback signals. By way of example, and without limitation, the first and second voltage dividers can include two capacitors that are electrically coupled in series.

In some embodiments, the phase compensation circuit includes at least one data capture element for storing at least one of said first and second filtered digital feedback signals and providing said stored filtered digital feedback signals to said phase comparator.

In some embodiments, at least one of the first and second digital waveform synthesizers includes a direct digital synthesizer. By way of example, each of the digital waveform synthesizers can generate any of a sinusoidal or a co-sinusoidal waveform.

In some embodiments, the first and second analog waveforms have two different frequencies. By way of example, any of the first and second analog waveforms has a frequency in a range of about 100 kHz to about 30 MHz.

In some embodiments, the first and second digital waveforms have different amplitudes. Any of the amplified analog waveforms can have, for example, a peak-to-peak amplitude in a range of about 20 volts to about 10,000 volts.

In a related aspect, a circuit for generating an asymmetric waveform for application to electrodes of a differential mobility mass (DMS) spectrometer is disclosed, which includes a first digital waveform synthesizer for generating a first digital waveform, a first digital-to-analog converter for receiving said first digital waveform and generating a first analog waveform, a second digital waveform synthesizer for generating a second digital waveform, a second digital-to-analog converter for receiving said second digital waveform and generating a second analog waveform, a feedback circuit configured to generate first and second analog feedback signals associated with said first and second analog waveforms, respectively, and converting said analog feedback signals to respective first and second digital feedback signals, a first and a second digital passband filter for receiving said first and said second digital feedback signals and generating a first and a second filtered digital feedback signal, respectively. The circuit can further include a phase comparator for receiving said first and second filtered digital feedback signals and generating first and second frequency spectra associated with said first and second digital feedback signals, respectively, said phase comparator further configured to employ said first and second frequency spectra to determine a phase difference between the first and second filtered digital feedback signals, and a controller configured to receive said phase difference and to generate a phase correction signal for application to at least one of said first and second digital waveform synthesizers for maintaining a substantially constant phase difference between the waveforms generated by said first and second waveform synthesizers.

In some embodiments, the phase comparator is configured to apply a discrete transform to said first and second filtered digital feedback signals to generate the first and second frequency spectra. By way of example, and without limitation, the discrete transform can be a Discrete Fourier Transform.

In some embodiments, the circuit can further include first and second amplifiers for receiving said first and second analog waveforms and generating first and second amplified analog waveforms.

In some embodiments, the circuit can further include first and second tank circuits for receiving said first and second amplified analog waveforms at inputs thereof, respectively, and generating first and second high-voltage analog waveforms at their respective outputs for application to said first and second electrodes of the DMS. In some embodiments, the tank circuits can be implemented using inductors and/or capacitors. In some embodiments, each tank circuit can be configured to exhibit resonance at a frequency corresponding to the frequency of the waveform applied thereto.

In some embodiments, the feedback circuit can include a first and a second voltage divider that are electrically coupled to the outputs of the first and the second tank circuits, respectively, to generate the first and the second analog feedback signals. The voltage dividers can be implemented using known techniques in the art as informed by the present teachings. For example, each voltage divider can be implemented as a plurality of capacitors connected electrically in series where the output of the voltage divider can correspond to a junction between two adjacent capacitors.

In some embodiments, the circuit can further include at least one data capture element for receiving at least one of the first and second filtered digital feedback signals and providing the captured filtered digital feedback signals to said phase comparator.

In some embodiments, at least one of the first and the second digital waveform synthesizers can include a direct digital synthesizer. Each digital waveform synthesizer can generate a periodic waveform, e.g., a sinusoidal or a co-sinusoidal waveform. In some embodiments, the first and the second digital waveform synthesizers provide waveforms at different frequencies such that the application of those waveforms to the electrodes of the DMS can result in generation of a desired FAIMS waveform.

By way of example, and without limitation, the digital waveform synthesizers can be configured to generate waveforms with a frequency in a range of about 100 kHz to about 30 MHz, e.g., in a range of about 1 MHz to about 5 MHz.

In some embodiments, the waveforms generated by the first and the second waveform generators can have different amplitudes. By way of example, and without limitation, the peak-to-peak amplitude of one waveform can be half of the corresponding amplitude of the other waveform. In some embodiments, the peak-to-peak amplitudes of each waveform can be in a range of about 20 volts to about 10,000 volts.

In a related aspect, a differential mobility mass (DMS) spectrometer is disclosed, which includes a first and a second electrode, a first digital waveform synthesizer for generating a first digital waveform, a first digital-to-analog converter for receiving said first digital waveform and generating a first analog waveform, a second digital waveform synthesizer for generating a second digital waveform, a second digital-to-analog converter for receiving said second digital waveform and generating a second analog waveform, a feedback circuit configured to generate first and second analog feedback signals associated with said first and second analog waveforms, respectively, and converting said analog feedback signals to respective first and second digital feedback signals, a first and a second digital passband filter for receiving said first and said second digital feedback signals and generating a first and a second filtered digital feedback signal, respectively.

The DMS can further include a phase comparator for receiving the first and second filtered digital feedback signals and generating first and second frequency spectra associated with the first and second digital feedback signals, respectively, where the phase comparator is further configured to employ the first and the second frequency spectra to determine a phase difference between the first and second filtered digital feedback signals and to generate a phase adjustment signal (herein also referred to as a phase correction signal) based on the phase difference. The DMS can further include a controller configured to receive the phase correction signal for application to at least one of the first and second digital waveform synthesizers for maintaining a substantially constant phase difference between the waveforms generated by the first and second waveform synthesizers.

In some embodiments, the phase comparator is configured to apply a discrete transform to the first and second filtered digital feedback signals to generate the first and second frequency spectra associated with those signals. By way of example, and without limitation, the discrete transform can be a Discrete Fourier Transform.

In some embodiments, the DMS spectrometer can include first and second amplifiers for receiving said first and second analog waveforms, respectively, and generating amplified first and second analog waveforms.

In some embodiments, the DMS spectrometer can include first and second tank circuits, which receive the first and second amplified analog waveforms at inputs thereof, respectively, and generate first and second high-voltage analog waveforms at their respective outputs for application to the electrodes of the DMS.

In some embodiments, the feedback circuit can include a first and a second voltage divider that are electrically coupled to the outputs of the first and the second tank circuits, respectively, to generate the first and the second analog feedback signals. In some embodiments, each of the first and second voltage dividers can include two or more capacitors that are electrically coupled in series.

In some embodiments, the DMS spectrometer can further include at least one data capture element for receiving at least one of the first and second filtered digital feedback signals and providing the captured filtered digital feedback signals to the phase comparator. In some other embodiments, such data capture elements are not utilized and the phase comparator can compute discrete transform of the digital feedback signals on the fly. By way of example, Discrete Fourier Transform (DFT) can be calculated in an iterative manner, where a current intermediate output value can be calculated from a previous intermediate output value and the current input sample. As the last input sample is added into the calculation, the computation yields the desired result. By way of example, in some embodiments, a computational algorithm commonly known as the Goetzel algorithm can be employed to implement such processing of the digital feedback signals on the fly.

The first and the second digital waveform synthesizers can be, for example, a direct digital synthesizer (DDS). In some embodiments, the direct digital synthesizers can generate a sinusoidal waveform, e.g., at a frequency in a range of about 600 kHz to about 5 MHz, e.g., in a range of about 1 MHz to about 2 MHz. The frequencies of the two waveforms can be different so as to generate a FAIMS waveform having a desired temporal profile. In some cases, the peak-to-peak amplitude of the high voltages applied to the electrodes of the DMS can be in a range of about 500 volts to about 5000 volts.

In some embodiments, the DMS can further include an auxiliary direct-current (DC) power supply for applying a DC bias voltage to at least one of the electrodes of the DMS. By way of example, the DC bias voltage can be in a range of 0 to about 500 volts.

Further understanding of various aspects of the present teachings can be obtained by reference to the following detailed description in conjunction with the associated drawings, which are described briefly below.

### BRIEF DESCRIPTION OF THE DRAWINGS

FIG. 1 schematically depicts a conventional circuit for generating a FAIMS waveform for application to electrodes of a DMS,

FIG. 2 schematically depicts a circuit according to an embodiment for generating a FAIMS waveform for application to electrodes of a DMS,

FIG. 3 schematically depicts an implementation of a tank circuit suitable for use in an embodiment of a circuit according to the present teachings for generating a FAIMS waveform for application to electrodes of a DMS,

FIGS. 4 and 5 schematically depict a DMS according to an embodiment of the present teachings, and

FIG. 6 schematically depicts an example of implementation of a phase comparator/controller in accordance with an embodiment of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

As noted above, a DMS spectrometer can separate ions based on their differential mobility in an asymmetric field generated via application of a separation voltage (SV) across two electrodes of the spectrometer. The separation voltage is commonly generated via application of sinewaves to the electrodes of the mobility cell. For example, the SV can be created by applying a 3 MHz sinewave to one electrode and a 6 MHz sinewave with half the amplitude to the other electrode. The resultant waveform, which will be herein referred to as a FAIMS waveform, can be utilized as the SV for separating ions based on their differential mobility. In order to generate a proper FAIMS waveform, there is a need to control a phase offset between the two sinewaves to a high degree of accuracy.

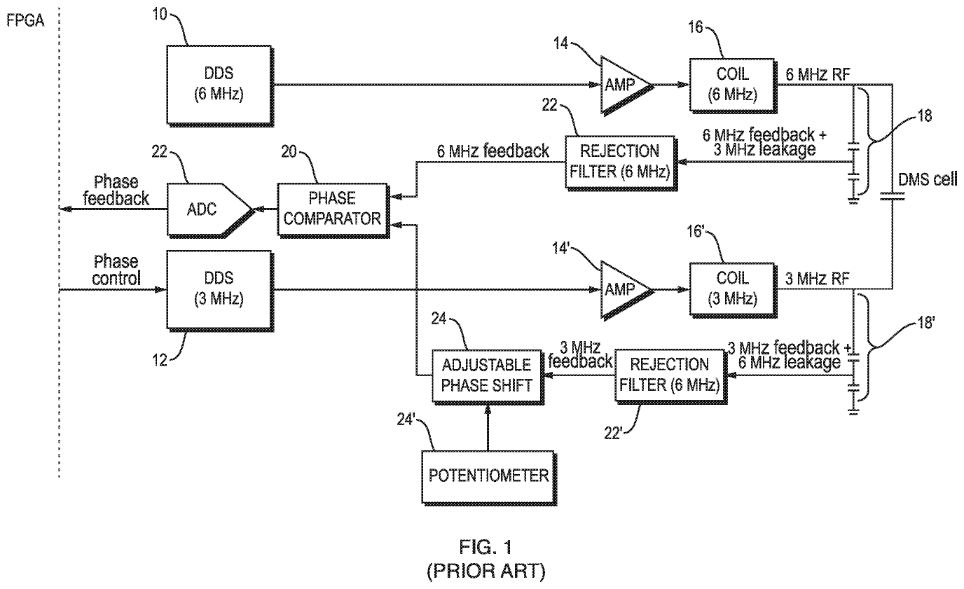

FIG. 1 schematically depicts a conventional circuit for generating a FAIMS waveform via application of two sinewaves with frequencies of 3 MHz and 6 MHz to the electrodes of a DMS cell. The circuit includes two digital direct synthesizers (DDSs) 10 and 12 for generating a 6 MHz and a 3 MHz sinewave, respectively. The 6 MHz sinewave is amplified via an amplifier 14 and is applied via a resonant circuit 16 to one of the electrodes of the DMS cell. The 3 MHz sinewave is, in turn, amplified via an amplifier 14′ and is applied via a resonant circuit 16′ to the other electrode of the DMS cell. Two voltage dividers 18 and 18′ coupled respectively to the outputs of the resonant circuits 16 and 16′ provide feedback signals associated with the 6 MHz and 3 MHz sinewaves, which can be utilized by a phase comparator 20 to provide analog phase feedback signals, which are converted via an analog-to-digital converter (ADC) to digital feedback signals for application to DDS 10 for maintaining a substantially constant phase offset between the two sinewaves.

The above circuit suffers, however, from a significant shortcoming. In particular, each of the 6 MHz and the 3 MHz sinewaves applied to the different electrodes of the DMS cell couple capacitively to the opposing electrode, resulting in feedback signals corresponding to a sum of the two frequencies. However, for proper functioning of the phase comparator, each of the 6 MHz and 3 MHz feedback signals should be as spectrally pure as possible. Therefore, the capacitively-coupled feedback signals need to be filtered in order to reduce, and preferably eliminate, their interference with the functioning of the phase comparator. In the depicted circuit, two analog rejection filters 22 and 22′ are utilized for filtering out the capacitively-coupled feedback signals. Such rejection filters, however, can exhibit a wide variation in phase response, e.g., due to incorporation of a large number of capacitors and inductors with significant tolerance, which results in a variable phase offset between each of the RF sinewaves and its respective feedback signal.

Consequently, the phase offset determined by the phase comparator may not correlate well with the true phase offset between the two sinewaves. In order to overcome this problem, an adjustable phase shifter 24, electrically coupled to a potentiometer 24′, can be inserted into one of the feedback paths, e.g., the 3 MHz feedback path in the depicted circuit, and a manual calibration can be performed as part of DMS manufacturing, during which the 3 MHz feedback signal is phase shifted until the FAIMS waveform “looks right” as observed on an oscilloscope. Such a calibration process is, however, time consuming and costly, and its accuracy relies on a visual evaluation of the FAIMS waveform by a human operator.

Moreover, the rejection coefficient of the rejection filters can be poor (e.g., 20 dB), resulting in a high noise floor in the phase rejection circuit. This can in turn necessitate maintaining a minimum SV in the DMS cell in order to ensure a proper functioning of the phase offset control loop even when such an SV is not desirable for a proper functioning of the DMS.

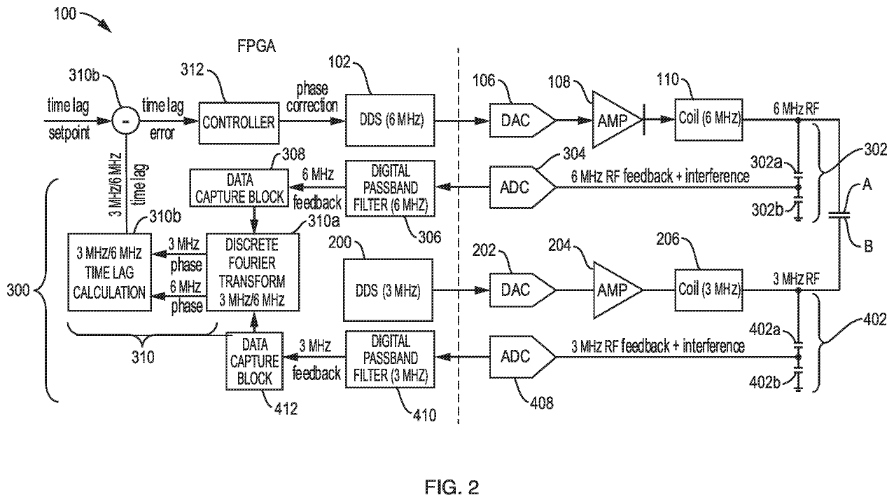

FIG. 2 schematically depicts a circuit 100 for use in a differential mobility mass (DMS) spectrometer for applying waveforms to the electrodes of a DMS cell. In this embodiment, the circuit 100 includes a digital direct synthesizer (DDS) 102 that generates a digital sinusoidal waveform (herein also referred to as a digital sinusoidal signal) at a frequency of about 6 MHz, which is received by a digital-to-analog converter (DAC) 106, which converts the digital waveform into a corresponding analog waveform. The analog waveform is amplified via an amplifier 108 to generate an amplified analog waveform for application to a tank circuit 110 of the DMS cell.

Another DDS 200 generates a second digital sinusoidal waveform at a frequency of about 3 MHz, which is received by a second digital-to-analog converter (DAC) 202. The DAC 202 generates an output analog sinusoidal waveform corresponding to the input digital sinusoidal waveform. The analog waveform is amplified by an amplifier 204 to generate an amplified analog sinusoidal waveform, which is received by another tank circuit 206 that generates a high voltage analog waveform for application to the other electrode of the DMS cell.

With continued reference to FIG. 2, in this embodiment, the circuit 100 includes a feedback circuit 300 that generates feedback signals by sampling the scaled down copies of the high voltage analog signals applied to the electrodes A and B and utilizes those feedback signals to generate a phase correction signal for aligning the phases of the sinusoidal waveforms generated by the DDS 102 and DDS 200.

More specifically, in this embodiment, a voltage divider 302 coupled at an input thereof to the output of the tank circuit 110 can generate a 6 MHz analog feedback signal. More specifically, in this embodiment, the voltage divider 302 is implemented as two capacitors 302a/302b that are electrically connected in series where the junction between the two capacitors corresponds to the output of the voltage divider. The voltage at the output of the voltage divider is a fraction of the voltage at the input of the voltage divider, e.g., in this case by a ratio of the impedance of the capacitor 302b at 6 MHz relative to the combined impedance of the capacitors 302a/302b at 6 MHz. The output voltage of the voltage divider 302 provides a first analog feedback signal that is received by an analog-to-digital converter (ADC) 304, which converts the analog feedback signal to a digital feedback signal associated with the 6 MHz sinusoidal waveform (herein also referred to as the first digital feedback signal).

The digital feedback signal associated with the 6 MHz sinusoidal waveform is received by a digital passband filter 306 that rejects any signal at a frequency of 3 MHz, which may have been coupled, via capacitive coupling, across the electrodes to the feedback signal at the frequency of 6 MHz, to generate a first digital feedback signal.

A data capture element 308 (herein also referred to as a data capture block) receives the first digital feedback signal and stores the signal for application to a phase comparator 310.

With continued reference to FIG. 2, another voltage divider 402 provides a second analog feedback signal, which is associated with the 3 MHz sinusoidal waveform. Similar to the voltage divider 302, the voltage divider 402 includes two capacitors 402a/402b that are electrically coupled in series with the voltage at the junction of the two capacitors corresponding to a second analog feedback signal, which is received by another ADC 408, which converts the analog feedback signal to another digital feedback signal associated with the 3 MHz sinusoidal waveform (herein also referred to as the second digital feedback signal).

The second digital feedback signal is received by a second digital bandpass filter 410, which rejects any signal at a frequency of 6 MHz, which may have been coupled via capacitive coupling across the electrodes to the feedback signal at the frequency of 3 MHz, to generate a second digital feedback signal. Another data capture block 412 receives the second digital feedback signal and stores the second digital feedback signal for application as another input signal to the phase comparator 310.

The phase comparator 310 includes a Discrete Fourier Transform module 310a that receives the first and the second filtered digital feedback signals and operates on those signals to generate the frequency spectra associated with the filtered digital feedback signals. The phase comparator 310 further includes a computational module 310b that receives the frequency spectra associated with the 6 MHz and the 3 MHz signals generated by the Discrete Fourier Transform module to determine a phase shift (e.g., in the form of a time lag) between the two feedback signals. The computational module 310b can also include functionality, as shown schematically in FIG. 2, to compare the measured phase shift with a preset phase shift (i.e., a desired phase shift between the two sinusoidal waveforms) to determine a phase error, i.e., the degree by which the measured phase shift deviates from the preset phase shift. A controller 312 receives the computed phase error from the phase comparator and generates a phase correction signal, in a manner known in the art as informed by the present teachings, for application to the DDS 102 so as to align the phases of the waveforms generated by DDS 102 and DDS 200.

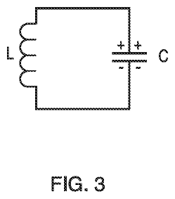

By way of illustration, FIG. 3 schematically depicts an example of implementation of a tank circuit for use in the above embodiment. The depicted tank circuit includes an inductor L that is coupled in parallel to a capacitor C. The inductance of the inductor L and the capacitance of the capacitor C can be selected, in a manner known in the art, such that the tank circuit would exhibit a resonant frequency that is substantially equal to the frequency of a signal that is applied to the tank circuit, e.g., the above 6 MHz or 3 MHz signals.

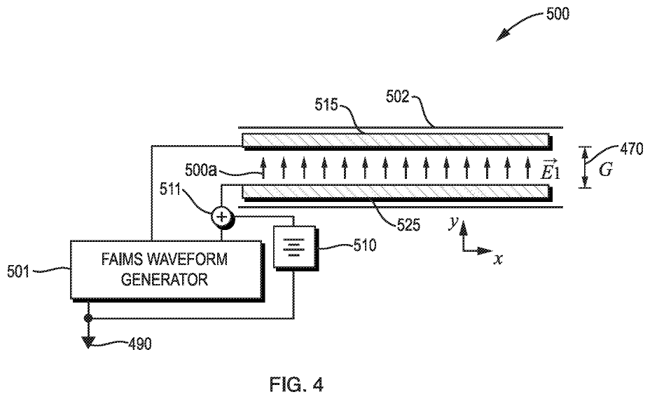

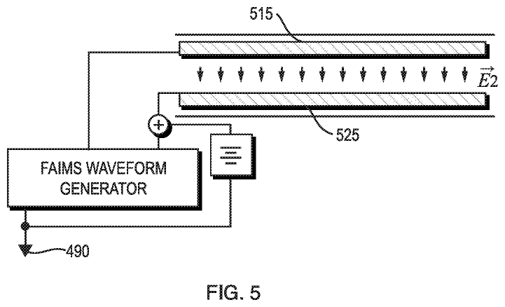

FIGS. 4 and 5 schematically depict a high-field asymmetric-waveform differential mobility mass spectrometer 500 in which an asymmetric waveform-generation circuit 501 according to the present teachings is incorporated. The DMS 500 includes a DMS cell 502 in which two electrodes 515 and 525, in the form of two plates in this embodiment, are positioned, where the electrodes are separated by a space through which the DMS can receive via an inlet 500a thereof a plurality of ions (not shown). In operation, a time-varying, asymmetric, electric field E1 and E2 is created between the two electrodes. By way of example, and without limitation, the electrodes can be parallel strip electrodes, parallel plate electrodes, concentric cylinders, curved elements, among others.

Ions travel between the electrodes along the x direction, orthogonal to the direction of the time-varying electric field. The asymmetric, time-varying electric field imparts a net drift to the ions in the y direction.

The FAIMS waveform generator 501 can be implemented in a manner discussed herein to provide an asymmetric time-varying electric field between the two electrodes to which the ions are exposed as they travel between the two electrodes.

The DMS 500 further includes an auxiliary direct-current (DC) power supply 510 that provides a DC voltage that can be added to the voltage of one of the waveform generators with a summing circuit device 511 to apply a substantially constant DC bias voltage, or offset voltage, to the electrode 525. In some embodiments, the DC bias voltage can be applied directly to one of the electrodes. The DC bias voltage can be used, for example, to place a target species of ions in a “balanced” condition between the two electrodes so that those ions can pass between the two electrodes with substantially no drift in a direction of either electrode and hence exit the DMS.

Various components utilized in a circuit according to the present teachings, such as the above asymmetric waveform generating circuit 100, are commercially available and/or can be implemented in a manner known in the art as informed by the present teachings.

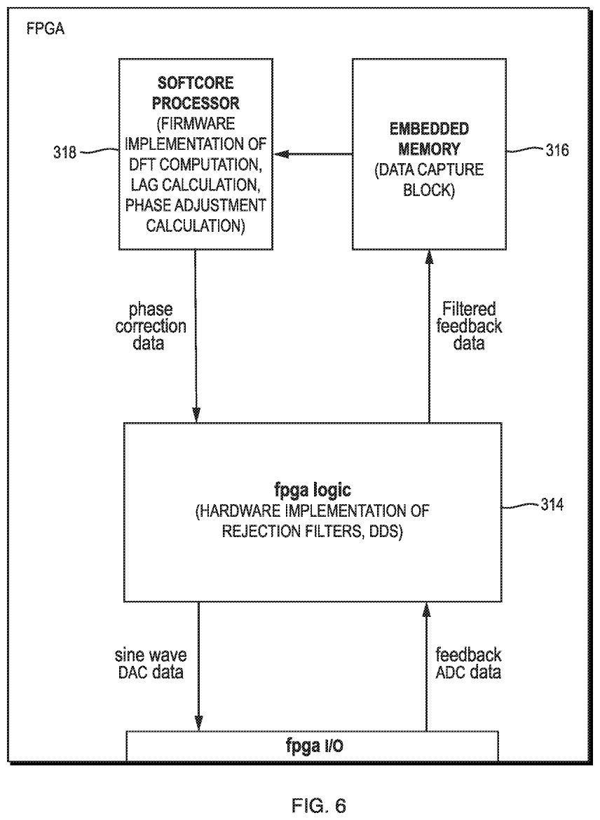

By way of example, the controller 312 and/or the phase comparator 310 can be implemented in hardware, firmware and/or software using techniques known in the art as informed by the present teachings. By way of example, FIG. 6 schematically depicts an example of such implementation.

As shown in FIG. 6, the controller 312 can be implemented using Field Programmable Gate Arrays (FPGAs). The exemplary implementation includes a logic module 314 that is a hardware implementation of the direct digital synthesizers (DDSs) as well as the digital passband filters. The logic module 314 is configured to receive the digital feedback signals from feedback ADCs via an I/O interface and operate on the digital feedback signals to generate filtered digital feedback signals, which are stored in an embedded memory 316 (herein also referred to as data capture block).

A softcore processor 318 can receive the data corresponding to the filtered digital feedback signals from the embedded memory 316 and operate on the data in a manner disclosed herein to obtain a phase difference between the digital feedback signals and further generate a phase correction signal.

More specifically, the softcore processor 318 is configured to apply a Discrete Fourier Transform (DFT) to the filtered digital feedback signals to generate frequency spectra corresponding to the filtered digital feedback signals. Further, the softcore processor 318 is configured to utilize the frequency spectra to compute a phase difference between the two filtered digital feedback signals and compare the computed phase difference with a preset phase difference (i.e., a desired phase difference) to generate phase adjustment (correction) data (signal), which is applied one of the DDSs for aligning the phases of the two DDSs.

Further, the digital waveforms generated by the DDS's including in the logic module 314 can be converted by external DACs to generate analog sinewaves, which can be amplified and applied to the electrodes in a manner discussed above.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

Those having ordinary skill in the art will appreciate that various changes can be made to the above embodiments without departing from the scope of the present teachings.

1. A phase compensation circuit for adjusting a phase difference between first and second analog waveforms applied to two electrodes of a differential mobility mass spectrometer, wherein said analog waveforms are generated based on first and second digital waveforms respectively produced by first and second digital waveform synthesizers, comprising:
a feedback circuit for generating first and second analog feedback signals each associated with one of said first and second analog waveforms,
at least one analog-to-digital converter configured to receive first and second analog feedback signals and convert said first and second analog feedback signals into respective first and second digital feedback signals,
at least one digital passband filter configured to receive said first and second digital feedback signals and generate first and second filtered digital feedback signals by substantially filtering out from each of the digital feedback signals associated with each waveform a contribution associated with the other waveform due to cross-talk between said analog waveforms applied to the electrodes,
a phase comparator for determining a phase difference between said first and second filtered digital feedback signals, and
a controller for applying a correction signal determined based on said phase difference to at least one of said first and second digital waveform synthesizers.

2. The circuit of claim 1, wherein said phase comparator is configured to apply a discrete transform to said first and second filtered digital feedback signals to generate first and second frequency spectra associated with said first and second filtered digital feedback signals and to utilize said first and second frequency spectra to determine said phase difference.

3. The circuit of claim 2, wherein said discrete transform comprises a Discrete Fourier Transform.

4. The circuit of claim 1, further comprising first and second amplifiers for receiving said first and second analog waveforms and generating first and second amplified analog waveforms.

5. The circuit of claim 1, further comprising a feedback circuit for generating said first and second digital feedback signals.

6. The circuit of claim 4, further comprising first and second tank circuits for receiving said first and second amplified analog waveforms at inputs thereof, respectively, and generating first and second output analog waveforms at their respective outputs for application to said first and second electrodes of the DMS.

7. The circuit of claim 6, wherein said feedback circuit comprises a first and a second voltage divider electrically coupled to the outputs of the first and the second tank circuits, respectively, to generate said first and second analog feedback signals, and wherein optionally each of said first and second voltage dividers comprises two or more capacitors that are electrically coupled in series.

8. The circuit of claim 6, wherein each of said first and second tank circuits comprises one or more inductors.

9. The circuit of claim 6, wherein said first and second tank circuits are configured to have a resonant frequency substantially equal to a frequency of said first and second digital waveforms, respectively.

10. The circuit of claim 1, further comprising at least one data capture element for storing at least one of said first and second filtered digital feedback signals and providing said stored at least one of said first and second filtered digital feedback signals to said phase comparator.

11. The circuit of claim 1, wherein either one or both of said first and second digital waveform synthesizers comprise a direct digital synthesizer.

12. The circuit of claim 1, wherein each of the first and second digital waveform synthesizers generates any of a co-sinusoidal and a sinusoidal waveform.

13. The circuit of claim 1, wherein said first and second analog waveforms have two different frequencies.

14. The circuit of claim 1, wherein either one or both of said first and second analog waveforms have a frequency in a range of about 100 kHz to about 30 MHz.

15. The circuit of claim 1, wherein said first and second digital waveforms have different amplitudes.

16. The circuit of claim 4, wherein either one or both of said first and second amplified analog waveforms have a peak-to-peak amplitude in a range of about 20 volts to about 10,000 volts.

17. A differential mobility mass (DMS) spectrometer, comprising:
a first and a second electrode,
a first digital waveform synthesizer for generating a first digital waveform,
a first digital-to-analog converter for receiving said first digital waveform and generating a first analog waveform,
a second digital waveform synthesizer for generating a second digital waveform,
a second digital-to-analog converter for receiving said second digital waveform and generating a second analog waveform,
a feedback circuitry configured to generate first and second analog feedback signals associated with said first and second analog waveforms, respectively, and converting said analog feedback signals to respective first and second digital feedback signals,
a first and a second digital passband filter for receiving said first and said second digital feedback signals and generating a first and a second filtered digital feedback signal, respectively,
a phase comparator for receiving said first and second filtered digital feedback signals and generating first and second frequency spectra associated with said first and second digital feedback signals, respectively, said phase comparator further configured to employ said first and second frequency spectra to determine a phase difference between the first and second filtered digital feedback signals, and
a controller configured to receive said phase difference and to generate a phase error signal for application to at least one of said first and second digital waveform synthesizers for maintaining a desired phase difference between the waveforms generated by said first and second waveform synthesizers.

18. The DMS spectrometer of claim 17, wherein said phase comparator is configured to apply a discrete transform to said first and second filtered digital feedback signals to generate said first and second frequency spectra.

19. The DMS spectrometer of claim 17, wherein said discrete transform comprises a Discrete Fourier Transform. (Currently Amended) The DMS spectrometer of claim 17, further comprising first and second amplifiers for receiving said first and second analog waveforms, respectively, and generating amplified first and second analog waveforms.
